(19) United States
(12) Patent Application Publication
(10) Pub. No.: US 2025/0302597 A1
(43) Pub. Date: Oct. 2, 2025

(54) ELECTROLYTIC ASSEMBLY, ORAL IRRIGATOR, AND ELECTRICAL APPLIANCE

(71) Applicant: GUANGZHOU DEPOSON ELECTRIC TECHNOLOGY CO., LTD., Guangzhou (CN)

(72) Inventors: Jianhua Zhong, Guangzhou (CN); Wenying Zhang, Guangzhou (CN); Yufu Pan, Guangzhou (CN)

(21) Appl. No.: 19/036,130

(22) Filed: Jan. 24, 2025

(30) Foreign Application Priority Data
Mar. 26, 2024 (CN) 202420604993.2
Jul. 9, 2024 (CN) 202410914876.0

(51) Int. Cl. A61C 17/02; C02F 1/461; C02F 103/02

(52) U.S. Cl. CPC A61C 17/02; C02F 1/46109; C02F 1/4618; C02F 2001/46142; C02F 2001/46185; C02F 2103/026; C02F 2201/004; C02F 2201/46115; C02F 2303/04

(57) ABSTRACT

The present invention provides an electrolytic assembly, comprising a shell and a stacked body, wherein the stacked body is provided inside the shell, and the stacked body comprises a first electrode, an electrolyte membrane, and a second electrode stacked in sequence, wherein the first electrode is connected to a conductive sheet, and the conductive sheet is provided with glue injection holes filled with conductive glue. The electrolytic structure is led out via small-area contacts of conductive sheets, which significantly reduces the area occupied by contacts compared to the way using the conventional large-area connected conductive contacts, and effectively improves the working area of the electrode, while miniaturizing the overall electrolytic structure.

### CROSS REFERENCE TO RELATED APPLICATIONS

The present application claims the benefit of Chinese Patent Application Nos. 202410914876.0 filed on Jul. 9, 2024 and 202420604993.2 filed on Mar. 26, 2024. All the above are hereby incorporated by reference in their entirety.

### TECHNICAL FIELD

The present invention relates to the field of electrolytic water technology.

### BACKGROUND

Aqueous solutions containing oxidizing groups can be produced through electrolysis devices, using water or aqueous electrolytes as raw materials. The structure of the electrolysis device consists of an anode and a cathode, or consists of an anode, a cathode and a membrane which is sandwiched between the anode and the cathode for proton exchange. The ozone, oxygen atoms, and hydroxyl radicals generated by electrolysis devices can effectively kill bacteria and viruses, and thus are perfect for applying in daily disinfection. In the existing electrolytic structure, it is necessary to precisely perform glue dispensing at the connection surface between the conductive sheet and the electrode, and then lock and fix the other end. During the fixing process, the conductive sheet may slide or bounce, which may contaminate the effective electrolytic area of the electrode sheet.

The electrolytic water structure can produce electrolyzed water that kills bacteria and viruses, and it can be converted into ordinary water after oxidation and sterilization, achieving green disinfection. So it is suitable for introducing into electrical appliances and various usage scenarios. However, introducing the electrolytic structure into the interior of electrical appliances will inevitably increase the overall volume, resulting in poor user experience and low portability. The current structure cannot meet the lightweight and portable needs of small electrical appliances.

### SUMMARY

Based on the above-mentioned problem, it is necessary to provide an electrolytic assembly, as well as an oral irrigator and electrical appliance comprising the electrolytic assembly.

An electrolytic assembly, comprising a shell and a stacked body, the stacked body is provided inside the shell, and the stacked body comprises a first electrode, an electrolyte membrane, and a second electrode stacked in sequence. The first electrode is connected to a conductive sheet, and the conductive sheet is provided with glue injection holes filled with conductive glue.

In one embodiment, a gap is formed between the conductive sheet and the first electrode, and the gap is filled with conductive glue.

In one embodiment, the conductive sheet is connected to a surface of the first electrode facing towards the second electrode.

In one embodiment, the electrolyte membrane is arranged to be staggered with the conductive sheet.

In one embodiment, one end of the conductive sheet away from the first electrode is connected to a first conductive pin.

In one embodiment, the conductive sheet and the first conductive pin are fixed to each other by bolts.

In one embodiment, the material of the first electrode and/or the second electrode is at least one of conductive silicon and conductive diamond, or the material of the first electrode and/or the second electrode is one of elemental titanium, elemental platinum, elemental lead, elemental tantalum, elemental iridium, elemental palladium, elemental antimony, titanium oxides, platinum oxide, lead oxides, tantalum oxides, iridium oxides, palladium oxides, or antimony oxides.

In one embodiment, a surface of the first electrode is a crystal structure, and relationship between a diameter D of the glue injection hole and a diameter d of crystal tip structure of the crystal is: 10d<D<1Md, where M represents million.

In one embodiment, the second electrode extends to form a conductive connection terminal, the conductive connection terminal is formed with a bent portion and the bent portion has elasticity.

In one embodiment, the conductive sheet is formed with a bent portion, and the bent portion has elasticity.

An oral irrigator, comprising an electrolytic assembly as described in any one of the above solutions.

In one embodiment, the oral irrigator further comprises a nozzle, a main body, and a water tank; the main body has an accommodating chamber, a motor and a water pump are provided inside the accommodating chamber, the motor is connected to the water pump for driving the water pump, the nozzle is connected to the main body, and the water pump is used for delivering water to the nozzle.

The electrolytic assembly is installed at the bottom of the main body and includes a module housing, and the electrolytic assembly is used for generating sterilizing water,

The water tank is connected to the main body, and the water pump is connected to a first end of a water supply pipeline. A second end of the water supply pipeline passes through the electrolytic assembly and extends into the water tank.

The present invention also provides an oral irrigator, including a nozzle, a main body, an embedded disinfection module, and a water tank. The main body has an accommodating chamber, a motor and a water pump are provided inside the accommodating chamber, the motor is connected to the water pump for driving the water pump, the nozzle is connected to the main body, and the water pump is used for delivering water to the nozzle.

The embedded disinfection module is installed at the bottom of the main body and includes a module housing and a disinfection assembly provided inside the module housing. The disinfection assembly is used for generating sterilizing water.

The water tank is connected to the main body, and the water pump is connected to a first end of a water supply pipeline. A second end of the water supply pipeline passes through disinfection assembly and extends into the water tank.

An electrical appliance, comprising an electrolytic assembly as described in any one of the above solutions.

The present invention has the following beneficial effects:
The electrolytic structure of the application is led out via small-area contacts of conductive sheets, which significantly reduces the area occupied by contacts compared to the way using the conventional large-area connected conductive contact, and effectively improves the working area of the electrode, while miniaturizing the overall electrolytic structure. In order to ensure the conductive connection between the conductive sheet and the electrode in the structure with small-area contact connection, the injected conductive glue can increase the conductivity of the contacts, reduce internal resistance, and ensure the electrolytic stability of the electrolytic assemblies. In the application, a glue injection hole is provided at one end of the conductive sheet connected to the electrode sheet, such that the conductive sheet can be fixed and installed at one end away from the electrode sheet in advance, and then conductive silver glue is injected into the glue injection hole to achieve connection to the electrode sheet. It avoids the precision requirements of precision glue injection on the conductive sheet connection surface in conventional structures, solves the problem of silver glue pollution on effective electrolytic area of the electrode sheet in the existing structure, reduces the contact area occupied by the contacts, while providing stable conductive connectivity, improving the effective electrolytic area of the electrode sheet, making the entire electrolytic structure more compact with a smaller size, and saving space, which particularly suitable for various small electrical appliances.

### BRIEF DESCRIPTION OF DRAWINGS

In order to provide a clearer explanation of the embodiments of the present invention or the technical solutions in the prior art, a brief introduction will be given to the accompanying drawings required for the description of the embodiments or the prior art. It is obvious that the accompanying drawings described below are only some embodiments of the present invention. For those skilled in the art, other drawings can be obtained based on these drawings without creative labor.

FIG. 1 is a schematic diagram of the structure of an electrolytic assembly according to an embodiment.

FIG. 2 is a schematic diagram of the structure of a stacked body according to an embodiment.

FIG. 3 is a partial schematic diagram of an electrolytic assembly according to an embodiment.

FIG. 4 is a partial schematic diagram of an electrolytic assembly according to another embodiment.

FIG. 5 is a schematic diagram of the structure of a conductive sheet according to an embodiment.

FIG. 6 is a schematic diagram of the structure of the second electrode according to an embodiment.

FIG. 7 is a schematic diagram of the structure of an oral irrigator according to an embodiment.

### DETAILED DESCRIPTION OF EMBODIMENTS

### Embodiment 1

The following will provide a clear and complete description of the technical solution in the embodiments of the present invention in conjunction with the accompanying drawings of embodiments of the present invention. Obviously, the described embodiments are only a part of the embodiments of the present invention, not all of them. Based on the embodiments in the present invention, all other embodiments obtained by an ordinary skilled person in the art without creative effort shall fall within the scope of protection of the present invention.

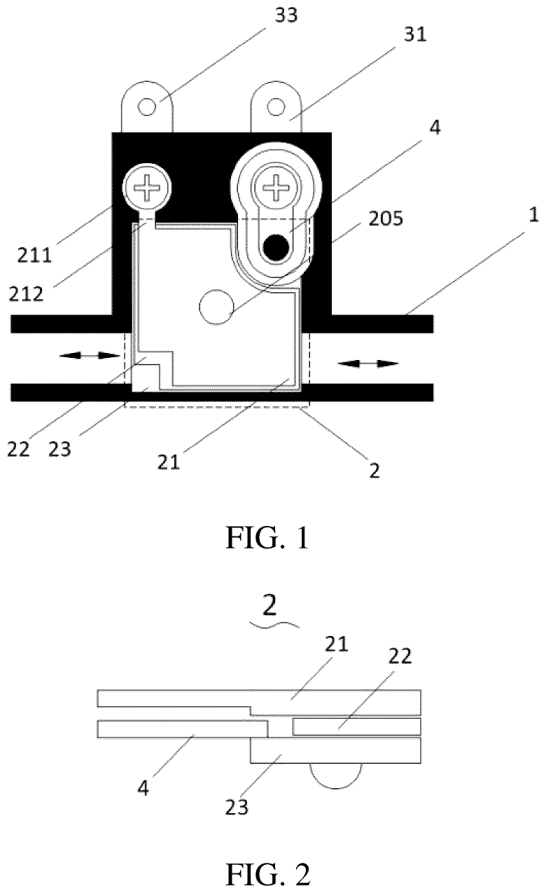

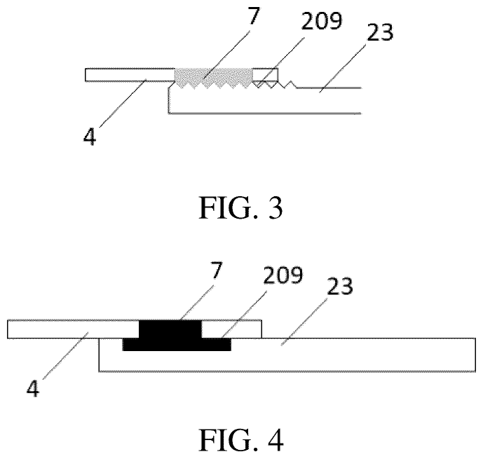

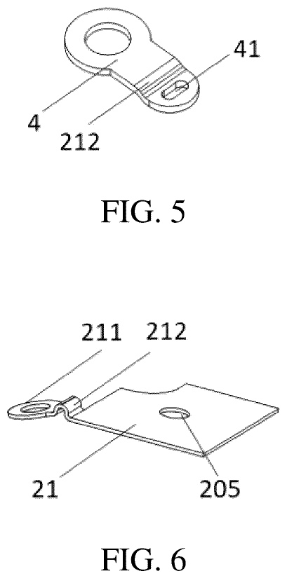

FIG. 1 to FIG. 6 shows an electrolytic assembly of a preferred embodiment of the present invention, and the electrolytic assembly comprises a shell 1 and a stacked body 2. The stacked body 2 is provided inside the shell 1, and the stacked body 2 comprises a first electrode 23, an electrolyte membrane 22, and a second electrode 21 stacked in sequence. The first electrode 23 is connected to a conductive sheet 4, and the conductive sheet 4 is provided with glue injection holes 41 filled with conductive glue 7.

In the existing technology, in order to ensure stable conductive connection, the conductive sheet is connected to the electrode sheet through a row of conductive contacts and is installed, resulting in the waste of effective electrolytic area. The electrolytic structure of the present application is led out via four small-area contacts of the conductive sheet, which significantly reduces the area occupied by the contacts compared to the existing row of large-area conductive contacts, and effectively improves the working area of the electrode, while miniaturizing the overall electrolytic structure. In order to ensure the conductive connection between the conductive sheet 4 and the electrode in the structure of small-area contact connection, the injected conductive glue 7 can increase the conductivity of the contacts, reduce internal resistance, and ensure the electrolytic stability of the electrolytic assemblies. In the application, a glue injection hole 41 is provided at one end of the conductive sheet 4 connected to the electrode sheet, such that the conductive sheet 4 can be fixed and installed at one end away from the electrode sheet in advance, and then conductive silver glue is injected into the glue injection hole 41 to achieve bonding between the conductive sheet and the electrode sheet. It avoids the precision requirements of precision glue dispensing on the connection surface of the conductive sheet 4 in conventional structures, solves the problem of silver glue pollution on effective electrolytic area of the electrode sheet in the existing structure, reduces the contact area occupied by the contacts, while providing stable conductive connectivity, improving the effective electrolytic area of the electrode sheet, making the entire electrolytic structure more compact with a smaller size, and saving space, which is particularly suitable for various small electrical appliances.

In order to achieve pre-fixation of one end of the conductive sheet 4 away from the electrode sheet before injecting glue, in one embodiment, one end of the conductive sheet 4 away from the first electrode 23 is connected to a first conductive pin 31. Furthermore, the conductive sheet 4 and the first conductive pin 31 are fixed to each other by bolts. For example, the conductive sheet 4 and the conductive pin are fixed onto the housing 1 by the bolts.

In one embodiment, a gap 209 is formed between the conductive sheet 4 and the first electrode 23, and the gap 209 is filled with conductive glue 7.

For example, a glue injection slot (the glue injection slot is the gap 209) is provided at a position where the first electrode 23 is connected to the conductive sheet 4. The conductive glue 7 enters the glue injection slot through the glue injection hole 41 and fills it, increasing the contact area between the conductive glue 7 and the first electrode 23 and between the conductive glue 7 and the conductive sheet 4, ensuring good conductive connectivity. After the conductive glue 7 solidifies, a stable connection between the conductive sheet 4 and the first electrode 23 may be achieved, improving the overall reliability of the electrolytic structure.

In one embodiment, the surface of the first electrode 23 is a crystal structure, that is, a material of a catalyst layer of the first electrode 23 is a crystal (or the entire first electrode 23 is formed of a crystal material). A top of the crystal is a sharp angular structure, that is, there is a gap 209 between crystal tips of the surface of the first electrode 23. Therefore, when the conductive sheet 4 is pressed on its surface, the gap 209 between the conductive sheet 4 and the crystal tip reduces its contact area, resulting in an increase in resistance and hindering conductive connectivity. Through the provided glue injection hole 41, the conductive glue 7 is injected and filled into the gap 209 formed between the conductive sheet 4 and the first electrode 23, thereby increasing the contact area, reducing resistance, and ensuring good conductive connectivity. After solidification of the conductive glue 7, a stable connection between the conductive sheet 4 and the first electrode 23 may be achieved, which improves the overall reliability of the electrolytic structure.

In order to provide better injection effect and enable the conductive glue 7 to flow from the glue injection hole 41 and fill into the gap 209, thereby ensuring a good contact area. In one embodiment, the relationship between a diameter D of the glue injection hole 41 and a diameter d of crystal tip structure of the crystal is: 10d<D<1Md, where M represents million. Within this range, the conductive glue can quickly and fully flow and fill into the gap, ensuring the stability of the conductive connection. In one embodiment, the material of the first electrode 23 and/or the second electrode 21 is at least one of conductive silicon and conductive diamond, or the material of the first electrode 23 and/or the second electrode 21 is one of elemental titanium, elemental platinum, elemental lead, elemental tantalum, elemental iridium, elemental palladium, elemental antimony, titanium oxides, platinum oxide, lead oxides, tantalum oxides, iridium oxides, palladium oxides, or antimony oxides. In one embodiment, the electrode materials of the first electrode 23 and the second electrode 21 are the same, and electrode conversion can be achieved between the first electrode 23 and the second electrode 21 by changing the current, thereby reducing the problem of calcium carbonate and other scale adhering to the electrode surface.

In one embodiment, the conductive sheet 4 is connected to one surface of the first electrode 23 facing towards the second electrode 21. Furthermore, the electrolyte membrane 22 is arranged to be staggered with the conductive sheet 4. In the present embodiment, by arranging the conductive sheet 4 connected to the first electrode 23 on one surface of the first electrode 23 facing towards the second electrode 21, i.e., arranging the conductive sheet 4 in the gap 209 between the first electrode 23 and the second electrode 21, the electrolyte membrane 22 is arranged to be staggered with the conductive sheet 4, thereby saving space in the thickness direction of the electrolytic structure. The entire electrolytic structure is more compact, with a smaller size, and is particularly suitable for various small electrical appliances.

The stacked body 2 of the present application is formed by a first electrode 23, a solid electrolyte membrane 22, and a second electrode 21 sequentially arranged, and the layers of a first electrode 23, a solid electrolyte membrane 22, and a second electrode 21 may be spaced apart from each other or surfaces of the layers may be attached to each other. For example, in order to facilitate the flow of water and gas, gaps 209 are provided between the first electrode 23 and the solid electrolyte membrane 22, as well as between the solid electrolyte membrane 22 and the second electrode 21. Alternatively, the first electrode 23 and/or the second electrode 21 is movable provided inside the electrolysis chamber. For example, the first electrode 23 and/or the second electrode 21 are provided with elastic structures that allow for slight movement to adjust the gaps 209 between the layers. In addition, the solid electrolyte membrane 22 is a Proton Exchange Membrane (PEM), which functions to provides a hydrogen ion channel, i.e., the H+ generated at the anode migrates to the cathode through the PEM, thereby increasing the reaction rate and product generation rate.

The first electrode 23 and the second electrode 21 are connected to an external power supply voltage such that the water flowing through is electrolyzed at low voltage to produce electrolyzed water. The electrolyzed water contains hydroxyl radicals, ozone, oxygen atoms and other oxidizing radical groups, which can achieve oxidation, sterilization and disinfection.

In order to achieve conductivity, in one embodiment, one end of the conductive sheet 4 away from the first electrode 23 is connected to a first conductive pin 31, and the first conductive pin 31 is connected to an external power source.

In order to achieve conductivity, in one embodiment, the second electrode 21 extends to form a conductive connection terminal 211. The conductive connection terminal 211 is connected to a second conductive pin 33, and the second conductive pin 33 is connected to an external power source.

In the existing structure, the grounding end extended from the electrode sheet is generally a planar structure or a right angled bending structure so as to be fixed and installed easily. The electrode sheet is limited by the installation position, which restricts the range of movement of the electrode sheet and makes it difficult to achieve effective vibration and displacement. The present application proposes an implementation solution. Specifically, the second electrode 21 is extended to form a conductive connection terminal 211, and the conductive connection terminal 211 is formed with a bent portion 212 having elasticity. The structure of the bent portion 212 of the electrode sheet eliminates the fixing fulcrum between the bent portion and the working section of the second electrode 212, allowing the second electrode 21 to achieve a certain degree of elastic movement while being fixed. Therefore, under different water pressure conditions, the electrode may move effectively, adjust the gap between the electrode sheet and the membrane, adjust the electrode spacing, and achieve balanced compression, thereby maintaining the stability of the electrolytic reaction. Moreover, it achieves elastic buffering while making the overall electrolytic structure more compact with a smaller size. Under the action of water flow, the electrode plate is in a micro oscillation state, which can effectively prevent the accumulation of the scale on the electrode surface.

For example, the conductive connection terminal 211 is installed on the second conductive pin 33 through a screw. The screw presses the second electrode 21 onto the solid electrolyte membrane 22 through the conductive connection terminal 211, while achieving elastic abutting. Compared with other existing elastic structures, the structure is more compact, can achieve an effect of a smaller volume, and has a smaller size.

This application proposes an implementation solution. Specifically, the conductive sheet 4 is formed with a bent portion 212, and the bent portion 212 has elasticity. The structure of the bent portion 212 of the conductive sheet 4 enables the first electrode 23 to achieve a certain degree of elastic movement while being fixed, and the vibration provided to the electrode can effectively prevent the accumulation of the scale. It adjusts the electrode spacing and achieves elastic buffering while making the overall electrolytic structure more compact with a smaller size.

In one embodiment, the first electrode 23, the electrolyte membrane 22, and the second electrode 21 are all provided with through holes 205. Through the provided through hole 205, water may flow from the first electrode 23 to the second electrode 21 and from the second electrode 21 to the first electrode 23, and the oxidizing radical groups generated between the electrodes and the solid electrolyte membrane 22 may be quickly carried away by the water flow.

The first electrode 23 and the second electrode 21 are determined by the power source or power voltage connected to them. By adjusting the power source or power voltage connected to it, electrode conversion may be achieved, thereby reducing the problem of calcium carbonate and other scale adhering to the electrode surface.

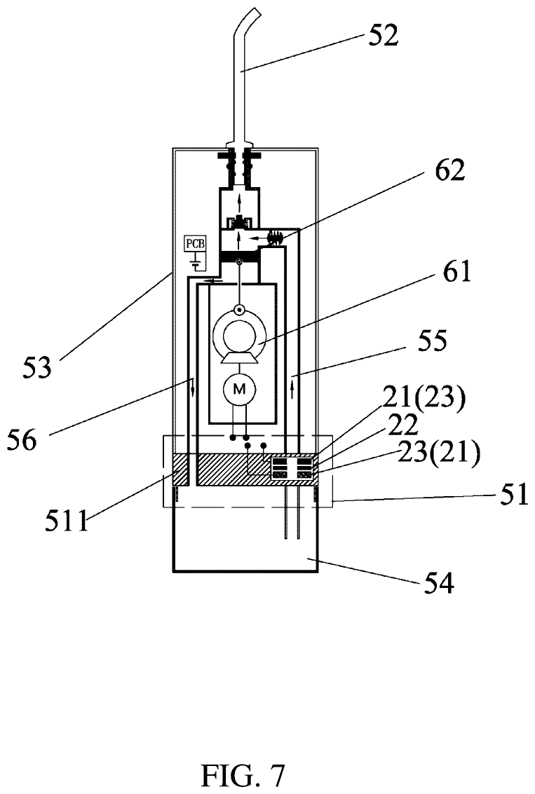

As shown in FIG. 7, the present application provides an oral irrigator comprising the electrolytic assembly 51 described above.

The above-mentioned oral irrigator further comprises a nozzle 52, a main body 53, and a water tank 54. The main body 53 has an accommodating chamber, a motor 61 and a water pump 62 are provided inside the accommodating chamber, the motor 61 is connected to the water pump 62 for driving the water pump 62, and the nozzle 52 is connected to the main body 53. The water pump 62 is used for delivering water to the nozzle 52.

The electrolytic assembly 51 is installed at the bottom of the main body 53 and includes a module housing 511, and the electrolytic assembly 51 is used for generating sterilizing water.

The water tank 54 is connected to the main body 53, and the water pump 62 is connected to a first end of a water supply pipeline 55, a second end of the water supply pipeline 55 passes through the electrolytic assembly 51 and extends into the water tank 54. That is to say, the water from the water tank is pumped out and delivered to the electrolytic assembly by the water pump, and the water is converted into electrolyzed water, also known as sterilizing water. The electrolyzed water is delivered to the nozzle and sprayed out, acting on the user's oral cavity. Electrolyzed water contains oxidizing radical groups such as ozone, oxygen atoms, and hydroxyl radicals and so on, which can effectively kill bacteria and viruses in the oral cavity, and serve the purpose of repairing gum and tooth and caring for the oral cavity. Simultaneously, sterilizing water may sterilize and disinfect the interior of pipelines and pumps, preventing the breeding of bacteria and viruses which can contaminate water. It is easy to be used, hygienic, and healthy. This electrolytic assembly has compact structure and has a smaller size, and is highly suitable for application in the products of oral irrigators.

In the present embodiment, the nozzle 52, the main body 53, and the water tank 54 are sequentially connected and arranged. The water pump 62 is started to pump the water from the water tank 62 into the water supply pipeline 55. When the water passes through the electrolytic assembly 51, the water is converted into sterilizing water. The sterilizing water is delivered to the water pump 62 through the water supply pipeline 55 and sprayed out through the nozzle 52. The sterilizing water may sterilize and clean the user's oral cavity, kill pathogenic bacteria in the oral cavity, and serve the purpose of oral care. At the same time, the sterilizing water may sterilize and disinfect the interior of pipelines and pumps, preventing bacteria and viruses, which can contaminate water, from breeding inside the pipeline and the water pump 62. It is easy to be used, hygienic and healthy.

Specifically, in one embodiment, the water pump 62 includes a piston and a one-way valve. The motor 61 is connected to the piston to drive the piston, and the piston reciprocates under the drive of the motor 61, causing a change in the volume of the chamber and generating suction and extruding forces. The water enters the water supply pipeline 55 from the water tank through the suction force, is converted into sterilized water through the electrolytic assembly 51, and is discharged towards the nozzle 52 through the extruding force.

In one embodiment, the oral irrigator further comprises a return pipeline 56. A first end of the return pipeline 56 is connected to the water pump 62, and a second end of the return pipeline 56 passes through the housing and is communicated with the water tank 54. The excess water in the water pump 62 can be returned to the water tank 54 through the return pipeline 56, and subjected to repeated circulation of the electrolytic assembly 51, the concentration of the sterilizing water may be increased and the reliability of sterilization may be improved.

In the preferred embodiment, the module housing 511 is detachably connected to the main body 53. The module housing 511 is installed a bottom of the main body 53 and embedded into the main body 53. For example, the main body 53 is provided with internal threads, and the module housing 511 has external threads. The internal threads mates with the external threads to achieve installation. Additionally, the module housing 511 is provided with a snap-fit structure, which will not be described in detail in the present embodiment. In the present embodiment, the shape of the module housing 511 may be configured according to actual production and may match existing oral irrigator products on the market such that the electrolytic assembly 51 can be directly implanted into the existing oral irrigator products.

In one embodiment, the water tank 54 is detachably connected to the module housing 511. The module housing 511 is implanted into the main body 53, and the water tank 54 may be detachably connected to the module housing 511 to facilitate water injection into the water tank.

In one embodiment, one end of the water supply pipeline 55 extending into the water tank is connected to a filter core. By providing the filter core, the water in the water tank can be roughly filtered. When using a water source such as tap water, impurities, chlorine, and other components may be removed through the filter core to improve the cleanliness of the water.

This application provides an electrical appliance comprising the electrolytic assembly as described above. The electrical appliance is, for example, an electric toothbrush, for example, a bidet, for example, a dishwasher, for example, a refrigerator sterilizer, and for example, a spray. And it will not be described in detailed for these examples one by one and will not enumerate in the present embodiment. By providing the electrolytic assembly inside the electrical appliance to discharge the electrolyzed water, external bacteria and viruses may be effectively killed, the home environment may be purified, and human health may be protected.

### Embodiment 2

As shown in FIG. 7, the present embodiment provides an oral irrigator comprising a nozzle 52, a main body 53, an embedded disinfection module, and a water tank 54. The main body has an accommodating chamber, and a motor 61 and a water pump 62 are provided inside the accommodating chamber. The motor 61 is connected to the water pump for driving the water pump, and the nozzle 52 is connected to the main body 53. The water pump 62 is used for delivering water to the nozzle 52.

The embedded disinfection module is installed at the bottom of the main body 53 and includes a module housing 511 and a disinfection assembly provided inside the module housing. The disinfection assembly is used for generating sterilizing water.

The water tank is connected to the main body 53. The water pump 62 is connected to a first end of a water supply pipeline 55, and a second end of the water supply pipeline 55 passes through disinfection assembly and extends into the water tank 54.

The oral irrigator in the present embodiment is similar to that in embodiment 1, except that an embedded disinfection module is installed instead of an electrolytic assembly. The embedded disinfection module may be an ozone generator or the electrolytic assembly in embodiment 1, but it is not limited to them. Other structures that have the disinfection function of the oral irrigator are also feasible and it is not limited.

The various technical features of the above embodiments can be combined in any way. In order to make the description concise, not all possible combinations of the various technical features in the above embodiments are described. However, as long as there is no contradiction in the combination of these technical features, they should be considered within the scope of the specification.

The above embodiments only express several implementations of the present invention, and descriptions in the above embodiments are more specific and detailed, but should not be understood as limiting the scope of the patent application. It should be pointed out that for those of ordinary skill in the art, several modifications and improvements can be made without departing from the concept of the present invention, and they should fall within the scope of protection of the present invention. Therefore, the scope of protection of the present invention should be based on the appended claims.

1. An electrolytic assembly, comprising a shell and a stacked body, wherein the stacked body is provided inside the shell, and the stacked body comprises a first electrode, an electrolyte membrane, and a second electrode stacked in sequence, wherein the first electrode is connected to a conductive sheet, and the conductive sheet is provided with glue injection holes filled with a conductive glue.

2. The electrolytic assembly according to claim 1, wherein a gap is formed between the conductive sheet and the first electrode, and the gap is filled with the conductive glue.

3. The electrolytic assembly according to claim 1, wherein the conductive sheet is connected to one surface of the first electrode facing towards the second electrode.

4. The electrolytic assembly according to claim 3, wherein the electrolyte membrane is arranged to be staggered with the conductive sheet.

5. The electrolytic assembly according to claim 1, wherein one end of the conductive sheet away from the first electrode is connected to a first conductive pin.

6. The electrolytic assembly according to claim 5, wherein the conductive sheet and the first conductive pin are fixed to each other by bolts.

7. The electrolytic assembly according to claim 1, wherein the material of the first electrode and/or the second electrode is at least one of conductive silicon and conductive diamond, or the material of the first electrode and/or the second electrode is one of elemental titanium, elemental platinum, elemental lead, elemental tantalum, elemental iridium, elemental palladium, elemental antimony, titanium oxides, platinum oxide, lead oxides, tantalum oxides, iridium oxides, palladium oxides, or antimony oxides.

8. The electrolytic assembly according to claim 1, wherein a surface of the first electrode is a crystal structure, and relationship between a diameter D of the glue injection hole and a diameter d of crystal tip structure of the crystal is: 10d<D<1Md, wherein M represents million.

9. The electrolytic assembly according to claim 1, wherein the second electrode extends to form a conductive connection terminal, the conductive connection terminal is formed with a bent portion and the bent portion has elasticity.

10. The electrolytic assembly according to claim 1, wherein the conductive sheet is formed with a bent portion, and the bent portion has elasticity.

11. An oral irrigator, comprising the electrolytic assembly as claimed in claim 1.

12. The oral irrigator according to claim 11, wherein the oral irrigator further comprises a nozzle, a main body, and a water tank; the main body has an accommodating chamber, a motor and a water pump are provided inside the accommodating chamber, the motor is connected to the water pump for driving the water pump, the nozzle is connected to the main body, and the water pump is used for delivering water to the nozzle;
the electrolytic assembly is installed at the bottom of the main body and comprises a module housing, the electrolytic assembly is used for generating sterilizing water;
the water tank is connected to the main body, and the water pump is connected to a first end of a water supply pipeline, a second end of the water supply pipeline passes through the electrolytic assembly and extends into the water tank.

13. A oral irrigator, comprising a nozzle, a main body, an embedded disinfection module, and a water tank;
the main body has an accommodating chamber, a motor and a water pump are provided inside the accommodating chamber, the motor is connected to the water pump for driving the water pump, the nozzle is connected to the main body, and the water pump is used for delivering water to the nozzle;
the embedded disinfection module is installed at the bottom of the main body and comprises a module housing and a disinfection assembly provided inside the module housing; the disinfection assembly is used for generating sterilizing water;
the water tank is connected to the main body, and the water pump is connected to a first end of a water supply pipeline, a second end of the water supply pipeline passes through disinfection assembly and extends into the water tank.
